(19) United States
(12) Patent Application Publication
(10) Pub. No.: US 2024/0364635 A1
(43) Pub. Date: Oct. 31, 2024

(54) DYNAMIC DISTRIBUTION OF CLIENT DEVICES IN GATEWAY CLUSTER

(71) Applicant: Hewlett Packard Enterprise Development LP, Spring, TX (US)

(72) Inventors: Raghunandan Prabhakar, Bangalore (IN); Sumanth Mithra, Bangalore (IN)

(21) Appl. No.: 18/139,819

(22) Filed: Apr. 26, 2023

(51) Int. Cl. H04L 47/24; H04L 47/122

(52) U.S. Cl. CPC H04L 47/24; H04L 47/122

(57) ABSTRACT

A system for facilitating the dynamic selection of a gateway at an access node is provided. During operation, the system can select primary and standby gateways for a client device coupling the access node from a list of gateways associated with a gateway cluster based on an identifier of the client device. The gateway cluster can include a plurality of gateways coupled to the access node. The system can then forward traffic from the client device to the primary gateway. If there is a change in a set of parameters associated with the gateway cluster, the system can receive a policy indicating a change of gateway for the client device. The set of parameters indicates performance associated with the plurality of gateways. The system can select a new primary gateway for the client device based on the policy and redirect traffic from the client device to the new primary gateway.

### BACKGROUND

### Field

The present disclosure relates to communication networks. More specifically, the present disclosure relates to a method and system for efficiently and dynamically selecting a gateway from a gateway cluster for individual client devices.

### BRIEF DESCRIPTION OF THE FIGURES

FIG. 1A illustrates an example of dynamically selecting a gateway from a gateway cluster for individual client devices, in accordance with an aspect of the present application.

FIG. 1B illustrates an example of dynamically selecting gateways from a gateway cluster for individual client devices for different operations, in accordance with an aspect of the present application.

FIG. 2 illustrates an example of dynamically selecting an active data gateway (ADG) and a standby data gateway (SDG) from a gateway cluster for a client device, in accordance with an aspect of the present application.

FIG. 3A illustrates an example of a communication for dynamically redirecting a data flow from a client device to a new ADG in a gateway cluster, in accordance with an aspect of the present application.

FIG. 3B illustrates an example of a roaming client device forwarding a data flow to a current ADG, in accordance with an aspect of the present application.

FIG. 4A presents a flowchart illustrating the process of a monitoring system determining a condition in a gateway cluster, in accordance with an aspect of the present application.

FIG. 4B presents a flowchart illustrating the process of a policy system providing a policy for selecting a gateway from a gateway cluster for individual client devices, in accordance with an aspect of the present application.

FIG. 4C presents a flowchart illustrating the process of a gateway synchronizing states with new ADGs and SDGs for facilitating the reallocation of client devices, in accordance with an aspect of the present application.

FIG. 4D presents a flowchart illustrating the initializing process of an ADG for supporting reallocated client devices, in accordance with an aspect of the present application.

FIG. 5A presents a flowchart illustrating the process of a device-designated gateway (DDG) facilitating failover to an SDG, in accordance with an aspect of the present application.

FIG. 5B presents a flowchart illustrating the process of a gateway for facilitating high availability to client devices, in accordance with an aspect of the present application.

FIG. 6 illustrates an example of a switch in a gateway cluster supporting dynamic allocation of client devices, in accordance with an aspect of the present application.

FIG. 7 illustrates an example of a computing system facilitating dynamic selection of a gateway from a gateway cluster for individual client devices, in accordance with an aspect of the present application.

FIG. 8 illustrates an example of an apparatus facilitating dynamic selection of a gateway from a gateway cluster for individual client devices, in accordance with an aspect of the present application.

In the figures, like reference numerals refer to the same figure elements.

### DETAILED DESCRIPTION

A set of gateways can be grouped together to form a gateway cluster for facilitating efficient connectivity to access nodes, such as wireless access points (APs) and access switches. In the cluster, a respective gateway can be a switch or a controller. A respective access node can be coupled to a respective gateway (e.g., via a tunnel). Furthermore, the gateways can be coupled to each other in a mesh. As a result, if a gateway becomes unavailable, another gateway in the cluster can detect the failure and facilitate efficient failover. Furthermore, the cluster can also provide load balancing at an access node by allowing the access node to select a gateway for individual client devices.

The cluster can include a leader responsible for computing a bucket map and publishing it to the access nodes. Publishing the bucket map can include selecting a device-designated gateway (DDG) for a respective access node. The DDG may establish a tunnel with the access node and can provide the bucket map and a nodelist, which is a list of gateways in the cluster, to the access node via the tunnel. The bucket map can include a respective gateway and a set of indices associated with the gateway. The same bucket map can be used for all access nodes coupling the cluster. When a new client device couples an access node, the access node can perform an exclusive OR (XOR) operation on the last three bytes of the media access control (MAC) address of the client device. The XOR operation can generate a one-byte value that can be used as an index for the bucket map. Based on the index, the access node can select the gateway for the client device. This selected gateway can be referred to as an active user-anchored gateway (A-UAG).

The subsequent communication from the client device, such as authentication requests, accounting requests, and data flow can be always forwarded to the A-UAG. As a result, even if the client device becomes associated with another access node (e.g., due to mobility), the same A-UAG is selected by the new access node. In this way, once selected, the A-UAG can remain persistent across all access nodes coupling the cluster. Furthermore, for every index in the bucket map, there can be a standby active user-anchored gateway (S-UAG). If the A-UAG becomes unavailable, the S-UAG can facilitate high availability to the corresponding client devices. However, the persistent nature of the bucket map may limit dynamic management, such as load distribution and policy enforcement, at the cluster.

The aspects described herein solve the problem of efficiently and dynamically selecting a gateway from a cluster for individual clients by (i) monitoring traffic load on a respective gateway of the cluster; (ii) providing one or more policies directed to traffic management to the cluster and the associated access nodes based on the monitoring; and (iii) redirecting traffic from the access nodes as indicated in the policies. If the bucket map selects the same gateway for a large number of client devices, the gateway can become overutilized. Based on the monitoring, a dynamic policy can be issued to ensure load balancing among the gateways in the cluster. A respective access node can then select a new gateway for individual client devices based on the policy and facilitate the dynamic selection of the gateways.

Typically, a network may deploy a large number of access nodes, such as APs and access switches. Each of the access nodes can be coupled to each gateway of a gateway cluster (e.g., via a tunnel). As a result, each access node can forward traffic to any of the gateways of the cluster. With existing technologies, a client device can become associated with an access node by establishing a wired or wireless connection with the access node. When the access node determines the presence of the client device, the access node can generate an index from the MAC address of the client device and look up the index in the bucket map. Based on the lookup operation, the access node can determine A-UAG and S-UAG for the client device. The A-UAG can then perform the authentication for the client device. Upon successful authentication, the access node can forward the data flow from the client device to the A-UAG.

Because the client devices can have wide-ranging MAC addresses, there can be a scenario where the MAC addresses of a large number of client devices correspond to the gateway in the bucket map. Since all client devices do not generate the same volume of traffic, the gateway may receive a large traffic volume from the access nodes while some other gateways in the cluster may remain underutilized. Such a scenario can lead to inefficient and imbalanced load distribution in the cluster. Furthermore, advanced operations, such as deep packet inspection (DPI) and packet filtering, can be performed on the processor of the gateway instead of the forwarding hardware. As a result, the processor of the gateway can incur a large load and become a bottleneck.

In addition, these client devices may send smaller packets, which has become a feature of many applications. Hence, the gateway may need to process at a high packet-per-second (PPS) leading to significant stress on the gateway. Moreover, the same gateway being responsible for both control and data traffic can limit flexibility in the network. In particular, the static nature of the bucket map does not allow policy-based data forwarding. For example, the gateways cannot be selected based on roles, such as admin, guest, engineer, etc., and associated privileges. Similarly, if a gateway supports advanced features, the bucket map may not allow traffic redirection to the gateway to utilize such features.

To solve this problem, the cluster can deploy a monitoring system and a policy system. These systems can be deployed either on the cloud (e.g., as a part of a provisioning and management system for the cluster) or on a gateway of the cluster. A respective gateway can report its performance vector, which can include parameters indicating traffic load, number of clients serving, processor utility levels, processing response time for a data flow (e.g., the time taken by the gateway to process packets of the data flow), etc., to the monitoring system. If a particular parameter reaches a threshold for a gateway, which can operate as an A-UAG for a set of client devices, the monitoring system can provide a notification indicating the condition to the policy system. Similarly, if a gateway incurs an error, such as an out-of-memory error or a kernel error, that can lead to unresponsive or degraded data forwarding (e.g., can cause a high response time) at the gateway, the monitoring system can provide a notification indicating the condition to the policy system. The policy system can then generate a policy to mitigate the condition and provide the policy to the gateways associated with the policy. The policy system can also instruct the access nodes to redirect traffic based on the policy.

For example, the policy can select a new primary gateway and a new standby gateway based on the current traffic load on the gateway. The new primary gateway can actively forward traffic and can be referred to as an active data gateway (ADG). On the other hand, the new standby gateway can provide high availability to the ADG and can be referred to as a standby data gateway (SDG). The gateway can synchronize its states with the new ADG and SDG. Such states can include user roles and virtual local area network (VLAN) mappings associated with the client devices for which the gateway operates as the A-UAG. When an access node receives the policy, the access node can configure the ADG as the gateway for the locally coupled subset of the set of client devices. Accordingly, the access node can start forwarding traffic from the subset of client devices to the ADG.

The policy system can issue other policies based on user configuration or dynamic generation. One such policy can be for redirecting traffic from client devices associated with a particular role to a subset of the gateways of the cluster. Another policy can be for redirecting traffic requiring container application processing, such as inspection by intrusion detection systems (IDS) and intrusion prevention systems (IPS), anti-virus scanning, and wide area network (WAN) compression to a set of gateways. The policies can also be associated with restrictive forwarding where traffic from certain client devices can be forwarded to a subset of gateways. For example, these policies can be for redirecting traffic to a subset of the gateways if the traffic is from client devices associated with a particular service set identifier (SSID) or a variation thereof, a particular subnet, and one or more MAC addresses. In this way, the dynamic policies can allow the gateway cluster to efficiently distribute and forward client traffic without overutilizing a gateway.

In this disclosure, the term “switch” is used in a generic sense, and it can refer to any standalone or fabric switch operating in any network layer. “Switch” should not be interpreted as limiting examples of the present invention to layer-2 networks. Any device that can forward traffic to an external device or another switch can be referred to as a “switch.” Any physical or virtual device (e.g., a virtual machine or switch operating on a computing device) that can forward traffic to an end device can be referred to as a “switch.” Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

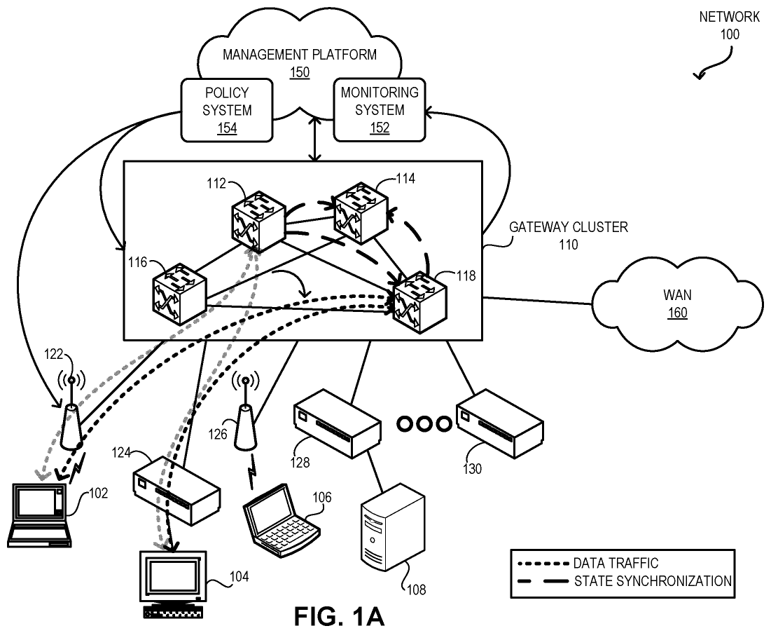

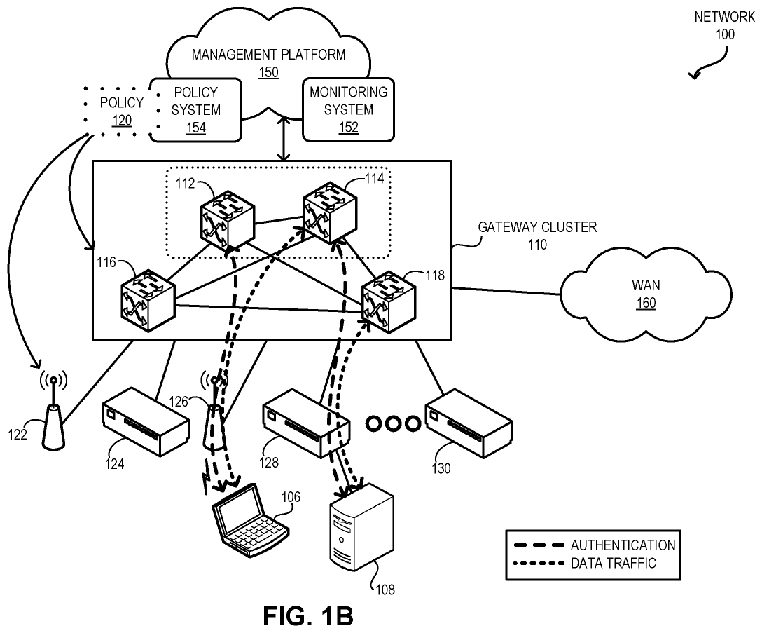

FIG. 1A illustrates an example of dynamically selecting a gateway from a gateway cluster for individual client devices, in accordance with an aspect of the present application. A network 100 can include a number of switches and devices, and may include heterogeneous network components, such as layer-2 and layer-3 hops, and tunnels. In some examples, network 100 can be an Ethernet, InfiniBand, or other networks, and may use a corresponding communication protocol, such as Internet Protocol (IP), FibreChannel over Ethernet (FCOE), or other protocol. Network 100 can include a gateway cluster 110 comprising a plurality of gateways 112, 114, 116, and 118. A respective gateway in cluster 110 can be a controller or a switch and can be coupled to all other gateways via respective tunnels, thereby forming a mesh. Cluster 110 can be coupled to a wide-area network (WAN) 160 for external communications.

Gateway cluster 110 can facilitate communication to a number of access nodes 122, 124, 126, 128, and 130. Access nodes 122, 124, 126, and 128 can couple client devices 102, 104, 106, and 108, respectively. Access nodes 122 and 126 can be wireless APs. On the other hand, access nodes 124, 126, and 130 can be access switches. A respective access node can be coupled to each gateway in cluster 110 via a tunnel. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). The tunnels in network 100 can be formed over an underlying network (or an underlay network). The underlying network can be a physical network, and a respective link of the underlying network can be a physical link. A respective switch pair in the underlying network can be a Border Gateway Protocol (BGP) peer.

Because each access node, such as access node 122, of network 100 can be coupled to each gateway in cluster 110, access node 122 can forward traffic to any of the gateways of cluster 110. With existing technologies, when client device 102 becomes associated with access node 122 by establishing a wireless connection, access node 122 can generate an index from the MAC address of client device 102 and look up the index in the bucket map. Based on the lookup operation, access node 122 can determine A-UAG and S-UAG for client device 102. Suppose that gateway 112 is selected as the A-UAG. Gateway 112 can then perform the authentication for client device 102. Upon successful authentication, access node 122 can forward the data flow from client device 102 to gateway 112. Similarly, gateway 112 can also be the A-UAG for client device 104. When gateway 112 authenticates client device 104, access switch 124 can forward the data flow from client device 104 to gateway 112. Hence, the same gateway 112 can be selected based on the indices generated from the MAC addresses of client devices 102 and 104.

As a result, gateway 112 may receive a large volume of traffic from access nodes 122 and 124 while other gateways, such as gateways 116 and 118, in the cluster may remain underutilized. Such a scenario can lead to inefficient and imbalanced load distribution in cluster 110. Furthermore, advanced operations, such as DPI and packet filtering, can be performed on the processor of gateway 112 instead of the forwarding hardware of gateway 112. As a result, the processor of gateway 112 can incur a large load and become a bottleneck.

In addition, client devices 102 and 104 may send smaller packets, which has become a feature of many applications. Hence, gateway 112 may need to process at a high PPS, which can cause significant stress on gateway 112. Moreover, the same gateway 112 being responsible for both control and data traffic can limit flexibility in network 100. Since the bucket map is static, policy-based data forwarding may not be supported in network 100. For example, gateway 112 cannot be selected based on roles, such as admin, guest, engineers, etc., and associated privileges of client devices 102 and 104. Similarly, if another gateway 116 supports advanced features, the bucket map may not allow redirection of traffic from end devices 102 and 104 to gateway 116 to utilize such features.

To solve this problem, cluster 110 can deploy a monitoring system 152 and a policy system 154. These systems can be deployed either on the cloud or on a gateway of cluster 110. For example, systems 152 and 154 can be deployed as a part of a management system 150, which can be used to provision, manage, and configure gateways in cluster 100. During operation, gateways 112, 114, 116, and 118 can report their respective performance vector to monitoring system 152. The performance vector of gateway 112 can include parameters indicating one or more of: traffic load, number of clients serving, processing response time for a data flow, and processor utility level of gateway 112. If a particular parameter reaches a threshold for gateway 112, monitoring system 152 can provide a notification (or event) indicating the condition to policy system 154. Similarly, if gateway 112 incurs an error, such as an out-of-memory error or a kernel error, that can lead to unresponsive or degraded data forwarding at gateway 112, monitoring system 152 can provide a notification indicating the condition to policy system 154.

For example, the condition can indicate that the traffic volume, the number of clients, or the processor utility level at gateway 112 is greater than the corresponding threshold. Policy system 154 can then generate a policy, which can include a set of configurations, to mitigate the condition at gateway 112. Policy system 154 can also obtain policies defined by a user (e.g., an administrator). Policy system 154 can then provide the policy to the gateways in cluster 110 and the access nodes.

If the condition indicates a high processor utility level at gateway 112, the policy can indicate an ADG and an SDG that have a low processor utility level with the ADG having a lower processor utility level. If the processor utility levels at gateways 118 and 114 are low, the policy can indicate gateways 118 and 114 as the ADG and the SDG, respectively. Gateway 112 can then synchronize its states with ADG 118 and SDG 114. Such states can include user roles and VLAN mappings associated with client devices 102 and 104. Here, gateway 112 can remain as the A-UAG for client devices 102 and 104 and may continue to receive control traffic from client devices 102 and 104. Gateway 112 can also send a gratuitous Address Resolution Protocol (ARP) message to an upstream switch (e.g., in WAN 160) to update the ARP table in the upstream switch.

When access nodes 122 and 124 receive the policy, access nodes 122 and 124 can configure gateway 118 as the ADG for client devices 102 and 104, respectively. Accordingly, access nodes 122 and 124 can start forwarding traffic from client devices 102 and 104, respectively, to gateway 118. Gateway 118 can also continue to synchronize states with gateway 114 for subsequent updates. If gateway 118 becomes unavailable, access nodes 122 and 124 can receive a corresponding notification from respective DDGs indicating the unavailability of gateway 118. Access nodes 122 and 124 can then start forwarding data traffic to gateway 114.

Policy system 154 can issue other policies based on user configuration or dynamic generation. For example, a policy can select a subset of the gateways of cluster 110 for a particular operation. FIG. 1B illustrates an example of dynamically selecting gateways from a gateway cluster for individual client devices for different operations, in accordance with an aspect of the present application. Policy system 154 can provide a policy 120 that can designate a subset of the gateways in cluster 110 for authentication. In cluster 110, gateways 112 and 114 can be selected for handling authentication requests from client devices. Policy 120 may also select gateways 112, 114, 116, and 118 for data traffic. As a result, gateways 112 and 114 may handle both control and data traffic. Cluster 110 can also be a heterogeneous cluster where gateways 116 and 118 can be high-performance devices equipped with configurations suitable for additional services, such as IDS, IPS, anti-virus scanning, WAN compression, and DPI. Policy 120 can then indicate gateways 116 and 118 as favorable for data traffic requiring the services.

Subsequently, policy system 154 can provide policy 120 to cluster 110 and the access nodes. When client device 106 becomes associated with access node 126, client device 106 can send an authentication request. Based on policy 120, access node 126 can apply a selection mechanism to gateways 112 and 114 and select gateway 112 for authentication. Access node 126 can also apply the selection mechanism to gateways 112, 114, 116, and 118, and select gateway 114 for the data traffic. Examples of the selection mechanism can include, but are not limited to, round-robin selection, hash-based selection, and priority-based selection. Upon successful authentication, client device 106 can start sending data traffic. Access node 126 can then forward the data traffic to gateway 114.

Similarly, based on policy 120, access node 128 can apply the selection mechanism to gateways 112 and 114 and select gateway 114 for authentication for client device 108. Hence, gateway 114 can be selected for authentication by access node 128 and for data traffic by access node 126. Suppose that data traffic from client device 108 requires additional processing. Access node 126 can then apply the selection mechanism to gateways 116 and 118 based on policy 120 and select gateway 118 for the data traffic. Upon successful authentication, client device 108 can start sending data traffic. Access node 128 can then forward the data traffic to gateway 118.

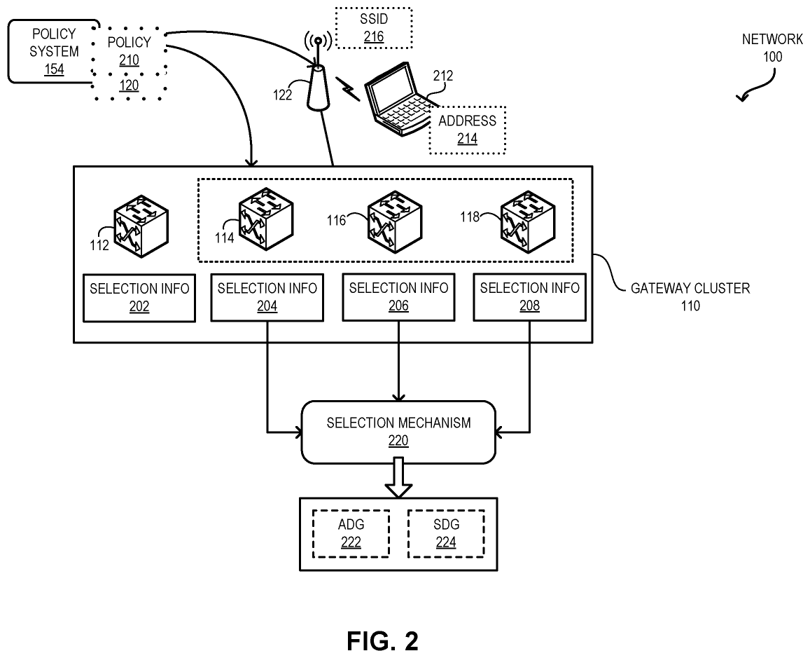

FIG. 2 illustrates an example of dynamically selecting an ADG and an SDG from a gateway cluster for a client device, in accordance with an aspect of the present application. In network 100, if client device 212 is wirelessly coupled to access node 122 based on its SSID 216. Policy system 154 can then generate a policy 210 (e.g., based on the configuration from a user) that can facilitate restrictive forwarding for client device 212. Accordingly, policy 210 can indicate that traffic from client device 212 can be forwarded to gateways 114, 116, and 118 in cluster 110. The restriction can be indicated by one or more of: a network address 214 of client device 212, SSID 216, and a subnet of address 214. Here, network address 214 can be an identifier of client device 212. Address 214 can include a MAC address or an Internet Protocol (IP) address and can be in a set of addresses associated with the restriction.

Access node 122 can then use a selection mechanism 220 on selection information 204, 206, and 208 of gateways 114, 116, and 118, respectively. However, if policy 210 specifies a new ADG and SDG for client device 212, access node 122 may determine ADG 222 and SDG 224 for client device 212 from policy 210 instead of applying selection mechanism 220. In the example in FIG. 1A, the policy issued from policy system 154 can specify gateways 118 and 114 as the new ADG and SDG. Under such circumstances, access node 122 can bypass the application of selection mechanism 220.

Since gateway 112 is excluded in policy 210, access node 122 is precluded from applying selection mechanism 220 on selection information 202 of gateway 112. Policy system 154 may also provide a plurality of policies. For example, policy 120 can also be applicable to cluster 110 and access node 122 in conjunction with policy 210. Here, policy 120 can indicate that gateways 112 and 114 should be used for authentication while policy 210 can indicate that gateway 112 should not be used for client device 212. Accordingly, access node 122 can forward the authentication request from client device 212 to gateway 114. If the combination of policies 120 and 210 excludes all gateways, there can be an error. Hence, prior to providing to cluster 110, policy system 154 can perform a validation on the combination of the policies to determine whether at least one gateway is available for a respective client device.

By applying selection mechanism 220, access node 122 can determine ADG 222 and SDG 224 for client device 212. If selection mechanism 220 includes a hash-based mechanism, selection information 204, 206, and 208 can be gateway numbers 0, 1, and 2 (e.g., an incremental integer value). Selection mechanism 220 can include performing an XOR operation on a portion of address 214 (e.g., the last 3 bytes) with policies 210 and 120 to obtain an XOR value. Since selection mechanism 220 is applicable on gateways 114, 116, and 118, the number of available gateways, N, for client device 212 can then be 3. Selection mechanism 220 can then determine an index for ADG 222 as (XOR value % N). If the index is 1, it can correspond to selection information 206. Hence, gateway 116 can be selected as ADG 222. Selection mechanism 220 can also determine an index for SDG 224 as ([index of ADG 222+1]% N). In this example, it can be the value of 2, which corresponds to selection information 208. Hence, gateway 118 can be selected as SDG 224. Gateways 116 and 118 can then synchronize state information to facilitate high availability to client device 212.

On the other hand, if selection mechanism 220 includes a priority-based mechanism, selection information 204, 206, and 208 can include a priority value associated with gateways 114, 116, and 118, respectively. Policy 210 can then include a list of gateways in order of priority. If selection information 204 and 208 corresponds to a highest priority and a lowest priority, respectively, for client device 212, policy 210 can include an ordered list comprising gateways 114, 116, and 118, which falls within the restrictions associated with network address 214 of client device 214, SSID 216, and a subnet of address 214. Selection mechanism 220 can then select gateway 114 as ADG 222 and gateway 116 as SDG 224 based on their respective priorities.

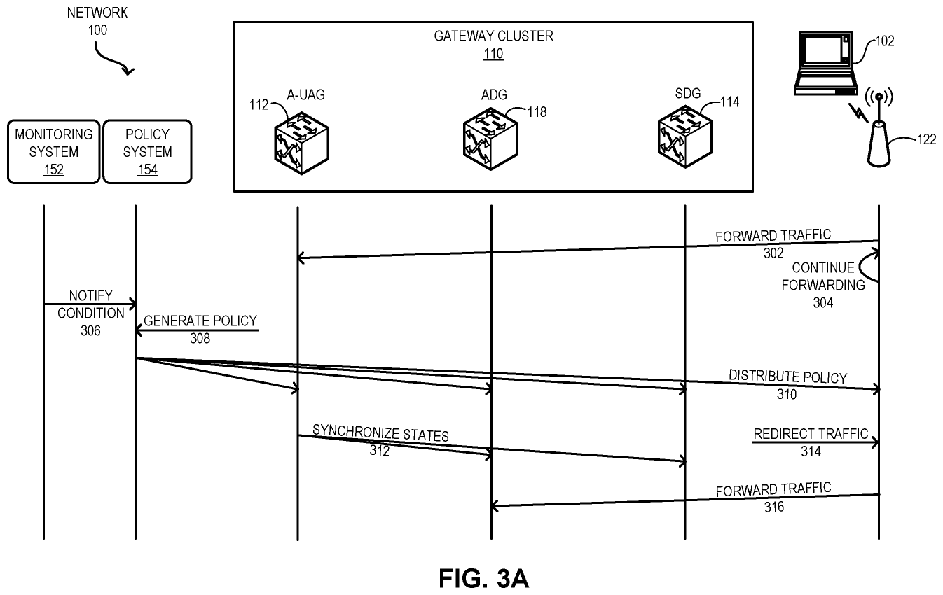

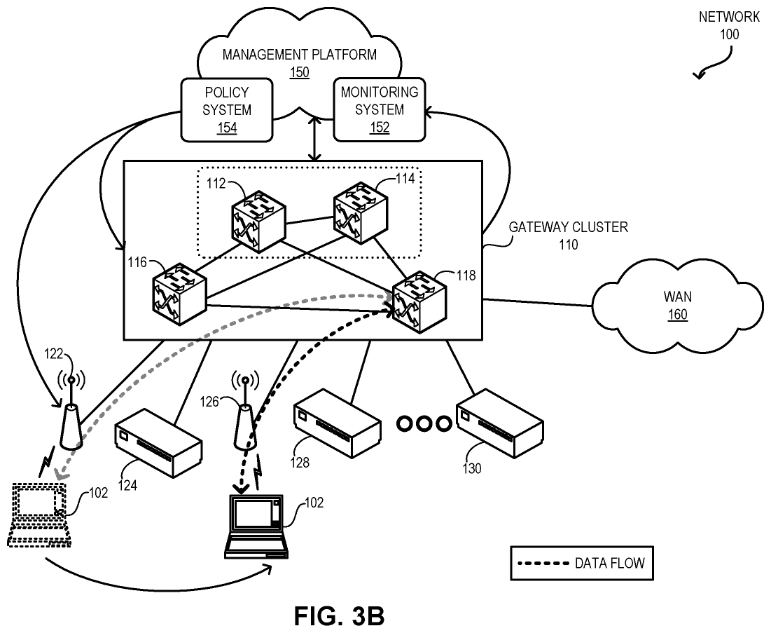

FIG. 3A illustrates an example of a communication for dynamically redirecting a data flow from a client device to a new ADG in a gateway cluster, in accordance with an aspect of the present application. If no initial policy is defined, access node 122 can select an A-UAG, which can be gateway 112, for client device 102 based on a bucket map received from a corresponding DDG of cluster 110. During operation, access node 122 can forward data traffic from client device 102 to gateway 112 (operation 302). Until a condition is detected, access node 122 can continue to forward data traffic to gateway 112 (operation 304). However, if monitoring system 152 detects a condition (e.g., a high processor utilization) associated with gateway 112, monitoring system 152 can notify policy system 154 regarding the condition (operation 306).

Policy system 154 can then generate a policy to mitigate the condition (operation 308). The policy can select gateways 118 and 114 as ADG and SDG, respectively, for client device 102. Policy system 154 can distribute the policy to cluster 110 and access node 122 (operation 310). When gateway 112 receives the policy, gateway 112 can synchronize the states with gateways 114 and 118 (operation 312). On other hand, when access node 122 receives the policy, access node 122 can redirect traffic from gateway 112 to gateway 118 (operation 314) and start forwarding traffic to gateway 118 (operation 316). In this way, the dynamic selection of a gateway can operate in conjunction with a bucket map.

FIG. 3B illustrates an example of a roaming client device forwarding a data flow to a current ADG, in accordance with an aspect of the present application. During operation, client device 102 can roam from the wireless coverage of access node 122 to access node 126 (denoted with dotted lines). Here, client device 102 has roamed from one AP to another AP. Access nodes 122 and 126 can use the same policy to determine gateway 118 as the ADG for client device 102. As a result, when access node 126 detects the presence of client device 102, access node 126 can forward traffic from client device 102 to gateway 118.

Because gateway 112 can remain as the A-UAG for client device 102, access node 126 can send a notification message to gateway 112 indicating the presence of client device 102. The notification message can be associated with an authentication server, such as a Remote Authentication Dial-In User Service (RADIUS) server. The notification message can then be a start message associated with RADIUS accounting. Based on the notification, gateway 112 can update the local VLAN multicast table at gateway 118 so that unicast traffic can be checked, and multicast traffic can flow in accordance with the policy.

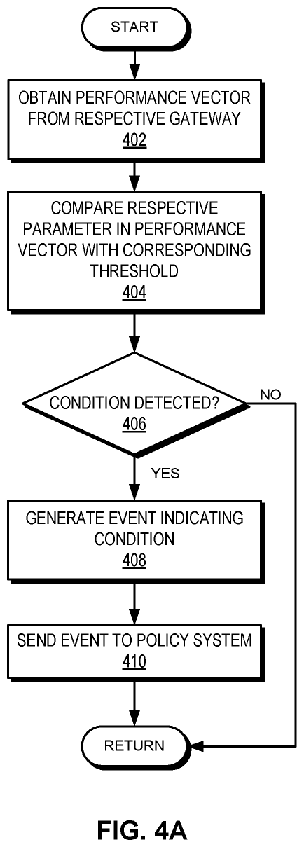

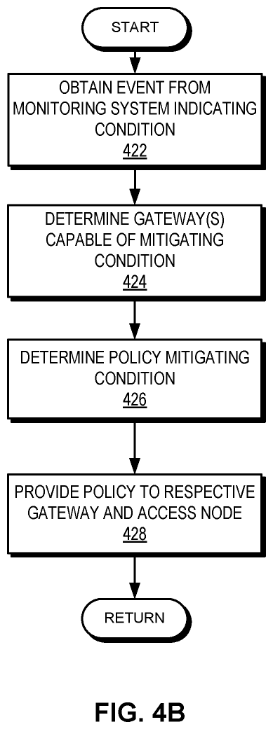

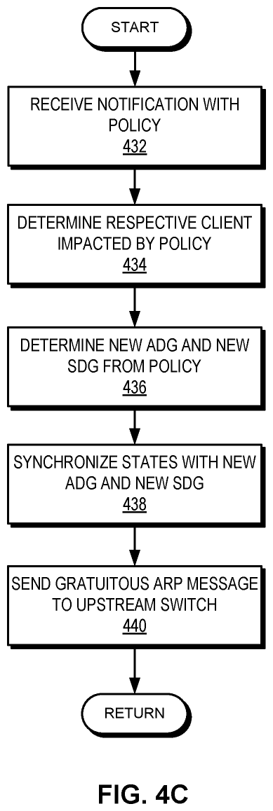

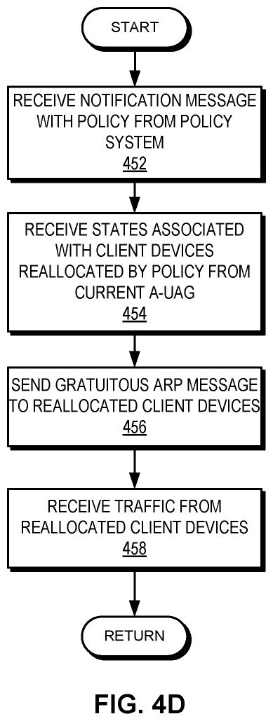

FIG. 4A presents a flowchart illustrating the process of a monitoring system determining a condition in a gateway cluster, in accordance with an aspect of the present application. During operation, the monitoring system can obtain a performance vector from a respective gateway (operation 402). The monitoring system can then compare a respective parameter in the performance vector with a corresponding threshold (operation 404) and determine whether a condition is detected (operation 406). If a parameter, such as processor utilization level, exceeds a corresponding threshold, a condition can be detected. The monitoring system can then generate an event indicating the condition (operation 408) and send the event to the policy system (operation 410).

FIG. 4B presents a flowchart illustrating the process of a policy system providing a policy for selecting a gateway from a gateway cluster for individual client devices, in accordance with an aspect of the present application. During operation, the policy system can obtain an event from the monitoring system indicating a condition (operation 422) and determine the gateway(s) capable of mitigating the condition (operation 424). The policy system can then determine a policy mitigating the condition (operation 426) and provide the policy to a respective gateway and access node (operation 428).

FIG. 4C presents a flowchart illustrating the process of a gateway synchronizing states with new ADGs and SDGs for facilitating the reallocation of client devices, in accordance with an aspect of the present application. During operation, the gateway can receive a notification with a policy (operation 432) and determine a respective client impacted by the policy (operation 434). The gateway can then determine a new ADG and a new SDG from the policy (operation 436) and synchronize states with the new ADG and the new SDG (operation 438). The gateway can also send a gratuitous ARP to an upstream switch (operation 440). The upstream switch can be a switch in an external network (e.g., a WAN).

FIG. 4D presents a flowchart illustrating the initializing process of an ADG for supporting reallocated client devices, in accordance with an aspect of the present application. During operation, the ADG can receive a notification message with a policy from the policy system (operation 452). The ADG can then receive states associated with the client devices reallocated by the policy from the current A-UAG (operation 454), thereby synchronizing the states between the ADG and the A-UAG. The ADG can also send a gratuitous ARP message to the reallocated client devices (operation 456). Subsequently, the ADG can receive traffic from the reallocated client devices (operation 458).

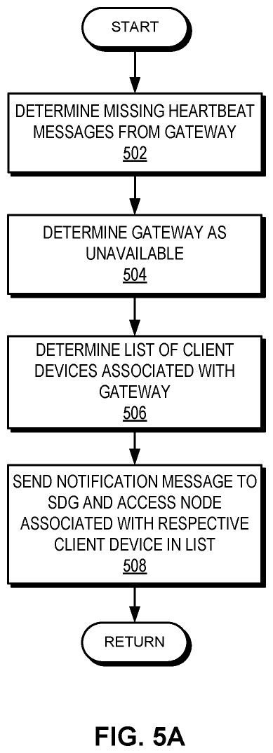

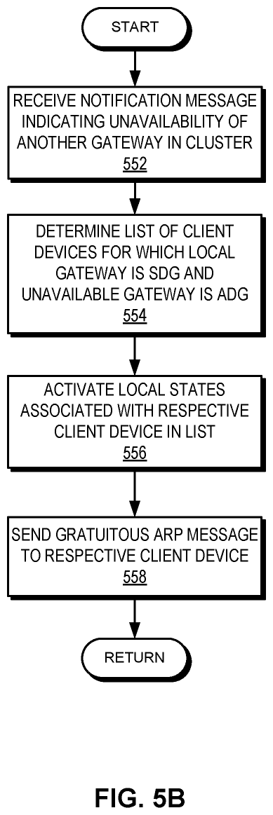

FIG. 5A presents a flowchart illustrating the process of a DDG facilitating failover to an SDG, in accordance with an aspect of the present application. During operation, the DDG can determine missing heartbeat messages from a gateway (operation 502) and determine the gateway as unavailable (operation 504). The DDG can then determine a list of client devices associated with the gateway (operation 506). The DDG can send a notification message to the SDG and the access node associated with a respective client device in the list (operation 508). The notification message can indicate the unavailability of the gateway and an updated nodelist that excludes the unavailable gateway.

FIG. 5B presents a flowchart illustrating the process of a gateway for facilitating high availability to client devices, in accordance with an aspect of the present application. During operation, the gateway can receive a notification message indicating the unavailability of another gateway in the cluster (operation 552). The gateway can then determine the list of client devices for which the local gateway is the SDG and the unavailable gateway is the ADG (operation 554). Subsequently, the gateway can activate the local states associated with a respective client device in the list (operation 556) and send a gratuitous ARP message to the respective client device (operation 558).

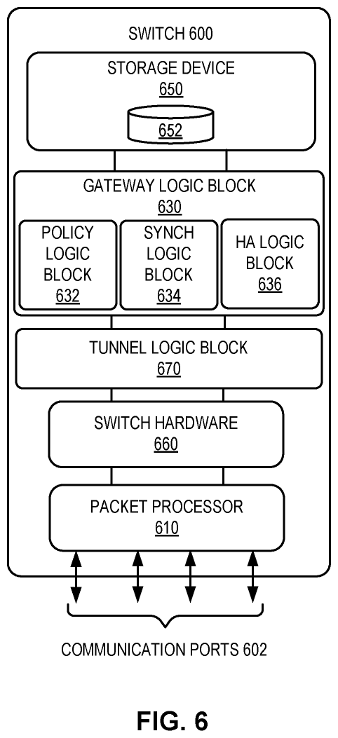

FIG. 6 illustrates an example of a switch in a gateway cluster supporting dynamic allocation of client devices, in accordance with an aspect of the present application. In this example, a switch 600 can include a number of communication ports 602, a packet processor 610, and a storage device 650. Switch 600 can also include switch hardware 660 (e.g., processing hardware of switch 600, such as its application-specific integrated circuit (ASIC) chips), which includes information based on which switch 600 processes packets (e.g., determines output ports for packets). Packet processor 610 can extract and processes header information from the received packets. Packet processor 610 can identify a switch identifier (e.g., a MAC address and/or an IP address) associated with switch 600 in the header of a packet.

Communication ports 602 can include inter-switch communication channels for communication with other switches and/or user devices. The communication channels can be implemented via a regular communication port and based on any open or proprietary format. Communication ports 602 can include one or more Ethernet ports capable of receiving frames encapsulated in an Ethernet header. Communication ports 602 can also include one or more IP ports capable of receiving IP packets. An IP port is capable of receiving an IP packet and can be configured with an IP address. Packet processor 610 can process Ethernet frames and/or IP packets. A respective port of communication ports 602 may operate as an ingress port and/or an egress port.

Switch 600 can maintain a database 652 (e.g., in storage device 650). Database 652 can be a relational database and may run on one or more Database Management System (DBMS) instances. Database 652 can store information associated with routing, configuration, and interface of switch 600. Database 652 may store cluster information, the states associated with one or more client devices, and a set of policies. Switch 600 can include a tunnel logic block 670 that can establish a tunnel with a remote switch, thereby allowing switch 600 to operate as a tunnel endpoint.

Switch 600 can include a gateway logic block 630, which can include a policy logic block 632, a synchronization logic block 634, and a high availability logic block 636. Policy logic block 632 can obtain a policy and configure switch 600 based on the policy. Synchronization logic block 634 can synchronize states with another switch for facilitating traffic redirection or high availability. High availability logic block 636 can provide high availability to another switch. For example, if switch 600 is the SDG, high availability logic block 636 can provide failover to an ADG and start forwarding the data flows previously passing through the ADG.

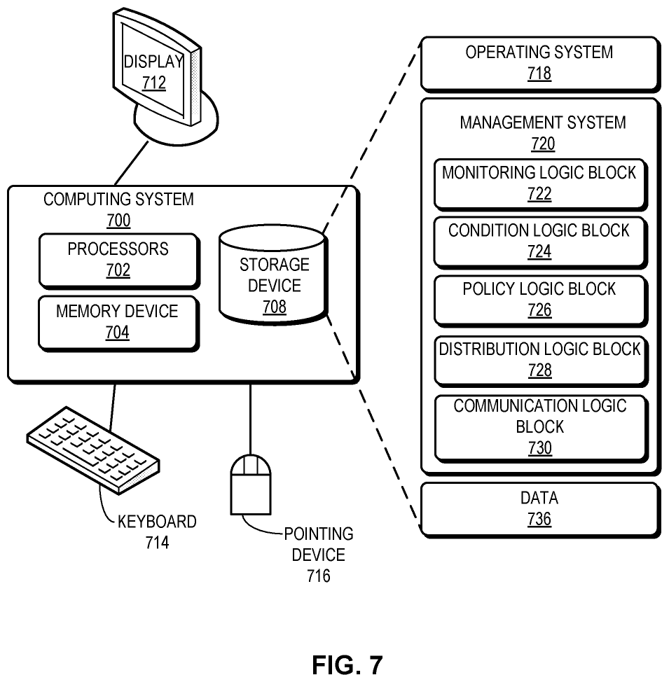

FIG. 7 illustrates an example of a computing system facilitating dynamic selection of a gateway from a gateway cluster for individual client devices, in accordance with an aspect of the present application. A computing system 700 includes a set of processors 702, a memory device 704, and a storage device 708. Memory device 704 can include a set of volatile memory devices (e.g., dual in-line memory module (DIMM)). Furthermore, computing system 700 may be coupled to a display device 712, a keyboard 714, and a pointing device 716, if needed. Storage device 708 can store an operating system 718, a management system 720, and data 736 associated with management system 720. Management system 720 can be a cloud service facilitating a monitoring system and/or a policy engine.

Management system 720 can include instructions, which when executed by system 700 can cause system 700 to perform methods and/or processes described in this disclosure. Specifically, management system 720 can include instructions for monitoring a respective gateway of a cluster and obtaining corresponding performance vectors based on the monitoring (monitoring logic block 722). Furthermore, management system y20 can include instructions for determining a condition based on the performance vectors (condition space logic block 724).

Management system 720 can include instructions for generating a policy for mitigating the condition (policy logic block 726). Management system 720 can also include instructions for receiving a policy configured by a user (policy logic block 726). Moreover, management system 720 can include instructions for distributing the policy to the gateways in a cluster and access nodes coupled to the cluster (distribution logic block 728). Management system 720 may further include instructions for sending and receiving messages (communication logic block 730). Data 736 can include any data that can facilitate the operations of management system 720. Data 736 can include, but are not limited to, information associated with the cluster and access nodes, dynamically-generated and user-configured policies, and a set of thresholds for determining the corresponding conditions.

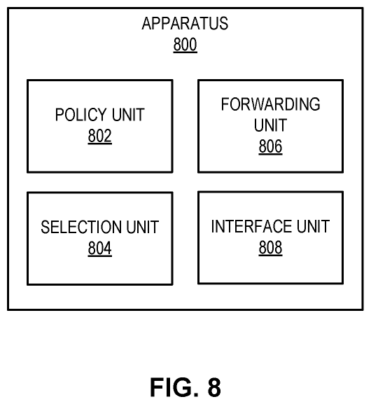

FIG. 8 illustrates an example of an apparatus facilitating dynamic selection of a gateway from a gateway cluster for individual client devices, in accordance with an aspect of the present application. Apparatus 800 can include a policy unit 802, a selection unit 804, a forwarding unit 806, and an interface unit 806. Apparatus 800 can operate as an access node. Selection unit 804 can select a first primary gateway and a first standby gateway for a client device coupling interface unit 806 (e.g., a wireless interface) from a list of gateways associated with a gateway cluster based on an identifier of the client device. Forwarding unit 806 can forward traffic from the client device to the first primary gateway. If there is a change in a set of parameters associated with the gateway cluster, policy unit 802 can receive a policy indicating a change of gateway for the client device. The set of parameters indicates performance associated with the plurality of gateways. Selection unit 804 can then select a second primary gateway for the client device based on the policy. Subsequently, forwarding unit 806 can redirect traffic from the client device from the first primary gateway to the second primary gateway.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a system for facilitating the dynamic selection of a gateway at an access node. During operation, the system can select a first primary gateway and a first standby gateway for a client device coupling the access node from a list of gateways associated with a gateway cluster based on an identifier of the client device. The gateway cluster includes a plurality of gateways coupled to the access node. The system can forward traffic from the client device to the first primary gateway. If there is a change in a set of parameters associated with the gateway cluster, the system can receive a policy indicating a change of gateway for the client device. The set of parameters indicates performance associated with the plurality of gateways. The system can select a second primary gateway for the client device based on the policy and redirect traffic from the client device from the first primary gateway to the second primary gateway.

In a variation on this aspect, the set of parameters can indicate includes one or more of: traffic load of a gateway, number of client devices served by the gateway, processing response time for the traffic, and processor utility levels of the gateway.

In a further variation, the policy can be generated in response to a parameter of the set of parameters reaching a threshold.

In a variation on this aspect, the access node can be one of: an access switch and a wireless access point (AP), and the AP can wirelessly couple the client device.

In a variation on this aspect, the list of gateways can be indicated in a bucket map published by a leader gateway of the gateway cluster. The system can select the first primary gateway by applying a binary logical operation to the identifier to determine an index. The system can then determine that the first primary gateway corresponds to the index in the bucket map.

In a variation on this aspect, the system can forward data traffic to the second primary gateway while forwarding control traffic to the first primary gateway.

In a variation on this aspect, the list of gateways can be indicated in a second policy published by a policy system. The list of gateways can include a subset of gateways of the gateway cluster selected by the second policy for control operations.

In a variation on this aspect, the system can receive a third policy indicating a subset of gateways of the gateway cluster. The subset of gateways can be allowed to be selected for the client device. The second primary gateway can be selected based further on the third policy.

In a variation on this aspect, the system can apply a selection mechanism to a subset of gateways of the gateway cluster to determine the second primary gateway. The selection mechanism can be based on one of: a hash function applicable to the identifier of the client device and a priority value associated with a respective gateway of the subset of gateways.

In a further variation, the subset of gateways can be indicated in the policy in association with one or more of: the identifier of the client device, a set of identifiers that includes the identifier of the client device, a service set identifier (SSID) associated with the access node, a subnetwork associated with the client device, and a capability of the subset of gateways.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method comprising:
selecting, by an access node, a first primary gateway and a first standby gateway for a client device coupling the access node from a list of gateways associated with a gateway cluster based on an identifier of the client device, wherein the gateway cluster includes a plurality of gateways coupled to the access node;
forwarding, by the access node, traffic from the client device to the first primary gateway;
in response to a change in a set of parameters associated with the gateway cluster, receiving, by the access node, a policy indicating a change of gateway for the client device, wherein the set of parameters indicates performance associated with the plurality of gateways;
selecting, by the access node, a second primary gateway for the client device based on the policy; and
redirecting, by the access node, traffic from the client device from the first primary gateway to the second primary gateway.

2. The method of claim 1, wherein the set of parameters indicates includes one or more of: traffic load of a gateway, number of client devices served by the gateway, processing response time for the traffic, and processor utility levels of the gateway.

3. The method of claim 2, wherein the policy is generated in response to a parameter of the set of parameters reaching a threshold.

4. The method of claim 1, wherein the access node is one of: an access switch and a wireless access point (AP), and the AP wirelessly couple the client device.

5. The method of claim 1, wherein the list of gateways is indicated in a bucket map published by a leader gateway of the gateway cluster;
wherein selecting the first primary gateway further comprises:
applying a binary logical operation to the identifier to determine an index; and
determining that the first primary gateway corresponds to the index in the bucket map.

6. The method of claim 1, further comprising forwarding, by the access node, data traffic to the second primary gateway while forwarding control traffic to the first primary gateway.

7. The method of claim 1, wherein the list of gateways is indicated in a second policy published by a policy system, and wherein the list of gateways includes a subset of gateways of the gateway cluster selected by the second policy for control operations.

8. The method of claim 1, further comprising receiving, by the access node, a third policy indicating a subset of gateways of the gateway cluster, wherein the subset of gateways is allowed to be selected for the client device, and wherein the second primary gateway is selected based further on the third policy.

9. The method of claim 1, further comprising applying, by the access node, a selection mechanism to a subset of gateways of the gateway cluster to determine the second primary gateway, wherein the selection mechanism is based on one of:
a hash function applicable to the identifier of the client device; and
a priority value associated with a respective gateway of the subset of gateways.

10. The method of claim 9, wherein the subset of gateways is indicated in the policy in association with one or more of:
the identifier of the client device;
a set of identifiers that includes the identifier of the client device;
a service set identifier (SSID) associated with the access node;
a subnetwork associated with the client device; and
a capability of the subset of gateways.

11. A non-transitory computer-readable storage medium storing instructions that when executed by a processor of an access node of a network cause the processor to perform a method, the method comprising:
selecting a first primary gateway and a first standby gateway for a client device coupling the access node from a list of gateways associated with a gateway cluster based on an identifier of the client device, wherein the gateway cluster includes a plurality of gateways coupled to the access node;
forwarding traffic from the client device to the first primary gateway;
in response to a change in a set of parameters associated with the gateway cluster, receiving a policy indicating a change of gateway for the client device, wherein the set of parameters indicates performance associated with the plurality of gateways;
selecting a second primary gateway for the client device based on the policy; and
redirecting traffic from the client device from the first primary gateway to the second primary gateway.

12. The non-transitory computer-readable storage medium of claim 11, wherein the set of parameters indicates includes one or more of: traffic load of a gateway, number of client devices served by the gateway, number of client devices served by the gateway, and processor utility levels of the gateway, and wherein the policy is generated in response to a parameter of the set of parameters reaching a threshold.

13. The non-transitory computer-readable storage medium of claim 11, wherein the access node is one of: an access switch and a wireless access point (AP), and the AP wirelessly couple the client device.

14. The non-transitory computer-readable storage medium of claim 11, wherein the list of gateways is indicated in a bucket map published by a leader gateway of the gateway cluster;
wherein selecting the first primary gateway further comprises:
applying a binary logical operation to the identifier to determine an index; and
determining that the first primary gateway corresponds to the index in the bucket map.

15. The non-transitory computer-readable storage medium of claim 11, wherein the method further comprises forwarding data traffic to the second primary gateway while forwarding control traffic to the first primary gateway.

16. The non-transitory computer-readable storage medium of claim 11, wherein the list of gateways is indicated in a second policy published by a policy system, and wherein the list of gateways includes a subset of gateways of the gateway cluster selected by the second policy for control operations.

17. The non-transitory computer-readable storage medium of claim 11, wherein the method further comprises receiving a third policy indicating a subset of gateways of the gateway cluster, wherein the subset of gateways is allowed to be selected for the client device, and wherein the second primary gateway is selected based further on the third policy.

18. The non-transitory computer-readable storage medium of claim 11, wherein the method further comprises applying a selection mechanism to a subset of gateways indicated in the policy to determine the second primary gateway, wherein the selection mechanism is based on one of:
a hash function applicable to the identifier of the client device; and
a priority value associated with a respective gateway of the subset of gateways.

19. The non-transitory computer-readable storage medium of claim 18, wherein the subset of gateways is indicated in the policy in association with one or more of:
the identifier of the client device;
a set of identifiers that includes the identifier of the client device;
a service set identifier (SSID) associated with the access node;
a subnetwork associated with the client device; and
a capability of the subset of gateways.

20. A computer system, comprising:
a processor;
a memory device; and
control circuitry to facilitate a selection logic block, a policy logic block, and a forwarding logic block;
wherein the selection logic block is to select a first primary gateway and a first standby gateway for a client device coupling the computer system from a list of gateways associated with a gateway cluster based on an identifier of the client device, wherein the gateway cluster includes a plurality of gateways coupled to the computer system;
wherein the forwarding logic block is to forward traffic from the client device to the first primary gateway;
wherein the policy logic block is to, in response to a change in a set of parameters associated with the gateway cluster, receive a policy indicating a change of gateway for the client device, wherein the set of parameters indicates performance associated with the plurality of gateways;
wherein the selection logic block is further to select a second primary gateway for the client device based on the policy; and
wherein the forwarding logic block is further to redirect traffic from the client device from the first primary gateway to the second primary gateway.
